(19) United States
(12) Patent Application Publication
(10) Pub. No.: US 2026/0359766 A1
(43) Pub. Date: Nov. 12, 2026

(54) Targeted Behavioral Compliance Monitoring

(71) Applicant: Proofpoint, Inc., Sunnyvale, CA (US)

(72) Inventors: Svetoslav Slaveikov Savchev, Toronto (CA); Greg Cameron Robinson, Toronto (CA)

(21) Appl. No.: 19/202,922

(22) Filed: May 8, 2025

(51) Int. Cl. G06Q 10/0639; G06F 16/358; G06Q 10/105

(52) U.S. Cl. CPC G06Q 10/06398; G06F 16/358; G06Q 10/105

(57) ABSTRACT

A method for targeted behavioral compliance monitoring is described. Smart review entries corresponding to communications stored in an archive are clustered. Each smart review entry corresponds to a communication, by a monitored employee, that matched an infoTag. A query for the clustered smart review entries is received. The query is a natural language query. The query is performed on the clustered smart review entries using retrieval-augmented generation (RAG). Query results from the query are provided for display in a user interface (UI).

### FIELD

This disclosure relates generally to supervision and, more specifically, to clustering behaviors of monitored employees to find suspicious behavior for compliance monitoring.

### BACKGROUND

Most employees earnestly try to follow rules and regulations to protect themselves and their employer. Due to the sensitive nature of the data that certain employees in specific roles interact with, governments have set requirements for companies to monitor those employees. These regulations include the ability to fine companies for not properly monitoring the specified employees. To comply with these regulations and to protect themselves and their customers, employers have contracted with companies to assist in the archiving of certain messages for monitored employees and to monitor for suspicious behaviors.

### SUMMARY

A method for targeted behavioral compliance monitoring is described. Smart review entries corresponding to communications stored in an archive are clustered. Each smart review entry corresponds to a communication, by a monitored employee, that matched an infoTag. query for the clustered smart review entries is received. The query is a natural language query. The query is performed on the clustered smart review entries using retrieval-augmented generation (RAG). Query results from the query for are provided display in a user interface (UI).

An action may be triggered in response to the clustered smart review entries. The action may include automatically sending stalling information to one or more monitored employees when a count for an infoTag corresponding to a crime has exceeded a threshold count for each of the one or more monitored employees. The action may also include sending a notification email to each supervisor of one or more monitored employees when a count for a specific infoTag has exceeded a threshold count for each of the one or more monitored employees. The action may be suggested by a large language model (LLM) in response to the smart review entries and infoTag counts.

The query results may be updated based on user feedback. Clustering the smart review entries may include feeding the smart review entries to a self-organizing map neural network based on unsupervised learning. Clustering the smart review entries may also include refining results from the self-organizing map neural network using K-means. The refined results may be fed to a large language model (LLM) to enhance reviewing with natural language capabilities. Each communication by a monitored employee that matches the infoTag may increment a count for the infoTag in the smart review entry. The query may indicate groups of monitored employees whose actions are outliers from other monitored employees. The query results may also include communications related to the communication that matched the infoTag.

A computing platform is described. The computing platform includes a memory and a processor. The processor is configured to execute instructions stored in the memory to cluster smart review entries corresponding to communications stored in an archive. Each smart review entry corresponds to a communication, by a monitored employee, that matched an infoTag. The processor is also configured to receive a query for the clustered smart review entries. The query is a natural language query. The processor is further configured to perform the query on the clustered smart review entries using retrieval-augmented generation (RAG). The processor is also configured to provide query results from the query for display in a user interface (UI).

A non-transitory computer readable medium is described that stores instructions operable to cause one or more processors to perform operations. The operations include clustering smart review entries corresponding to communications stored in an archive. Each smart review entry corresponds to a communication, by a monitored employee, that matched an infoTag. The operations also include receiving a query for the clustered smart review entries. The query is a natural language query. The operations further include performing the query on the clustered smart review entries using retrieval-augmented generation (RAG). The operations also include providing query results from the query for display in a user interface (UI).

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 depicts an illustrative operating environment for utilizing smart review entries and infoTags for employee supervision in accordance with one or more example embodiments.

FIG. 2 is a block diagram of an example of a system for performing targeted behavioral compliance monitoring.

FIG. 3 is an example of a technique for clustering smart review entries for communications stored in an archive database.

FIG. 4 is an example of a technique for querying clustered smart review entries for communications stored in an archive database.

FIG. 5 is a block diagram illustrating an example user interface (UI) for a query and corresponding results on clustered smart review entries.

FIG. 6 is a block diagram illustrating the solution stack for clustering smart review entries.

### DETAILED DESCRIPTION

Companies are often required to monitor the activities and behavior of employees in specific roles. These monitored employees may interact with highly sensitive information or may have access to tools that could break laws or interfere with the company operations. There may also be governmental requirements that companies monitor specific employees and that any monitored activities that are out of compliance be promptly reported. Failure to properly monitor employees and/or report on compliance issues can result in large fines for the company. In some cases, these fines have exceeded $100 million. Thus, there is a need for better compliance monitoring.

One common monitoring requirement is to monitor all messages sent and received by a monitored employee. These may include emails, text messages, and chats. Monitoring tools may also be capable of monitoring conversations during video conferences, phone calls, and conversations within conference rooms, depending on the specific monitoring requirements. Monitored employees are informed of the content that is monitored and the risks of not complying with requirements; no employee activities are monitored without their knowledge and consent. Typically, a monitored employee is aware that certain positions within a company (such as a stockbroker) have monitoring requirements and they agree to the monitoring requirements as a condition of their employment.

Typically, all messages to and from a monitored employee are stored in an archive. The archive acts as a repository to store these communications in case a monitored employee or an employer is ever accused of non-compliance. Although these archives can be searched, they are very large and can be cumbersome to search. Furthermore, new compliance regulations require that employee activities be regularly monitored (not just stored in an archive) and that any detected violations are reported soon after detection. Thus, maintaining a searchable archive database of messages is not sufficient.

Companies may set up basic rules (such as tagging any emails that state that they will take the conversation “offline”) and those messages that violate the rules may be automatically tagged and provided to a person to review for compliance violations. However, not every violation of a rule is a compliance violation. For example, a monitored employee may suggest taking a conversation offline so that they can discuss a potential fantasy football trade. Any parts of the communications involving a monitored employee that appear suspicious are tagged and forwarded to a review team that must then investigate the suspicious behavior and determine whether it is a compliance violation. Depending on the number of reviewers and on the number of monitored employees (and also on the number of suspicious behaviors tagged for additional review), there could be a significant amount of time between when a suspicious behavior occurs and when that behavior is reviewed. Furthermore, reviewers do not typically have access to all the necessary information to make an informed decision about whether a compliance violation occurred. A reviewer may not have access to the next few messages sent by a monitored employee after suspicious behavior and the reviewer may not have access to any of the messages sent by the other participant in the suspicious behavior (e.g., the person receiving the message that included suspicious behavior).

An archive system may utilize infoTags to better track the messages and other communications of a monitored employee. Each infoTag may be associated with a word or phrase that an employer wishes to track. In each monitored communication, whenever the word or phrase associated with an infoTag is detected, a smart review entry may be updated by incrementing a count for the specific infoTag and the monitored employee. Certain infoTags may trigger an automatic review when they occur only once (such as a word or phrase suggesting commission of a crime). Other infoTags may only trigger review when they represent an outlier (e.g., a group of monitored employees each using language suggesting a conspiracy to perform insider trading). Smart review entries may also be searchable at any time and across any time period for communications stored within the archive. For example, a reviewer may query for communications by monitored employees that referenced a particular social security number within a particular month to search for compliance violations.

One advantage of utilizing infoTags and corresponding smart review entries is the ability for one reviewer to explore complex data using natural language prompts efficiently. Another advantage is the ability for compliance violations to be quickly tagged and for a single reviewer to access other related communications that might indicate conspirators in compliance violations or provide additional evidence regarding a compliance violation. By providing more context to a single reviewer about a communication (including who that monitored employee communicated with immediately prior to the suspect communication, who that monitored employee communicated with immediately after the suspect communication, and additional information about those communications), a reviewer can utilize artificial intelligence for proactive supervision of monitored employees. A neural network can cluster multiple smart review entries and find outliers automatically or in response to a query. The use of infoTags and smart review entries can help companies monitor employees for suspicious behavior and find insights from complex data.

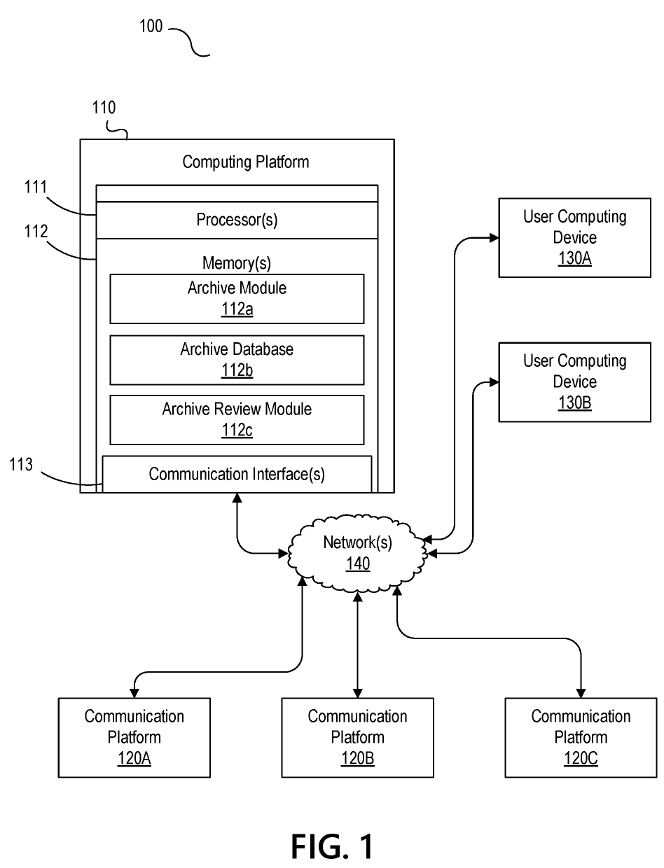

FIG. 1 depicts an illustrative operating environment 100 for utilizing smart review entries and infoTags for employee supervision in accordance with one or more example embodiments. Referring to FIG. 1, a computing environment 100 may include various computer systems, computing devices, networks, and/or other operating infrastructure. For example, the computing environment 100 may include a computing platform 110, communication platforms 120, user computing devices 130, and one or more network(s) 140.

Network(s) 140 may include one or more wired networks and/or one or more wireless networks that interconnect the computing platform 110, communication platforms 120, user computing devices 130, and/or other computer systems and/or devices. In addition, each of the computing platform 110, communication platforms 120, and user computing devices 130 may be special purpose computing devices configured to perform specific functions, as illustrated in greater detail below, and may include specific computing components such as processors, memories, communication interfaces, and/or the like.

The computing platform 110 may include one or more processor(s) 111, one or more memory(s) 112, and one or more communication interface(s) 113. In some instances, the computing platform 110 may be made up of a plurality of different computing devices (e.g., arranged as a computing platform), which may be distributed within a single data center or a plurality of different data centers. In these instances, the one or more processor(s) 111, one or more memory(s) 112, and one or more communication interface(s) 113 included in the computing platform 110 may be part of and/or otherwise associated with the different computing devices that form the computing platform 110.

In one or more arrangements, processor(s) 111 may control operations of the computing platform 110. Memory(s) 112 may store instructions that, when executed by the processor(s) 111, cause the computing platform 110 to perform one or more functions, as discussed below. The communication interface(s) 113 may include one or more wired and/or wireless network interfaces, and the communication interface(s) 113 may connect the computing platform 110 to one or more networks (e.g., network 140) and/or enable the computing platform 110 to exchange information and/or otherwise communicate with one or more devices connected to such networks.

In one or more arrangements, memory(s) 112 may store and/or otherwise provide a plurality of modules (which may include instructions that may be executed by processor(s) 111 to cause the computing platform 110 to perform various functions) and/or databases (which may store data used by the computing platform 110 in performing various functions). For example, the memory(s) 112 may store and/or otherwise provide an archive module 112a, an archive database 112b, and an archive review module 112c.

In some instances, the archive module 112a may store instructions that cause the computing platform 110 to implement communication archiving, and/or one or more other functions described herein. For example, the archive module 112amay receive communications to and from a customer (such as a company). In one configuration, the archive module 112amay receive emails, text messages, voice communications, and chat messages for all (or most) employees of the customer. In another configuration, the archive module 112a may only receive communications for monitored employees (e.g., employees with a contractual obligation to have their communications monitored for compliance purposes).

The archive module 112a may store communications in an archive database 112b. The archive database 112bmay provide a platform for the storage of digitally captured communications for a customer. Communications stored in the archive database 112b may be stored indefinitely or may be deleted periodically based on compliance rules (e.g., deleted after 7 years). A customer or a regulator may be able to access the communications stored within the archive database 112b for audits or other compliance measures. Typically, the communications stored in the archive database 112b are only accessible by those that have been authorized to access the archive database 112b (and thus the communications stored in the archive database 112b are not independently searchable by third parties or even by employees of the customer or administrators of the computing platform 110).

The archive review module 112c may provide authorized access to communications within the archive database 112b. For example, the archive review module 112cmay authenticate a user that is attempting to access the archive database 112b and then assist the user with searches of the archive database 112b. Designated reviewers (either employees of the customer, employees of a third party (such as an auditor or a government entity), or employees of the administrator) may be given access to the archive database 112b via the archive review module 112c to investigate compliance concerns (or other suspicious behavior).The archive review module 112cmay analyze communications as they are placed in the archive database 112b, create/modify smart review entries and infoTag counts for monitored employees, and cluster the smart review entries to enable efficient searching of the archive database 112b to find outliers or other suspicious behaviors. An authorized user can then utilize a query to find suspicious behaviors within the clustered smart review entries.

The communication platforms 120 may be configured to send and receive messages using a communications service. For example, the communication platforms 120 may be a consumer device or any other device that may be used to send messages to users and receive messages from users.

The user computing devices 130 may be configured to be used by respective users to receive messages from the communication platforms 120, and may also be able to send messages. The user computing devices 130 could be user-owned devices, employer-provided devices, or other types of devices used by respective users. The user computing devices 130 may be configured to present one or more user interfaces associated with messaging functions as described below.

In one or more arrangements, a communication service involves many different devices, and any given device may be able to receive and send various types of messages, including text messages, emails, and chats, from and to any number of other devices. As used herein, the communication platforms 120 and the user computing devices 130 may represent respective senders and recipients of messages in order to illustrate one or more aspects of the disclosure.

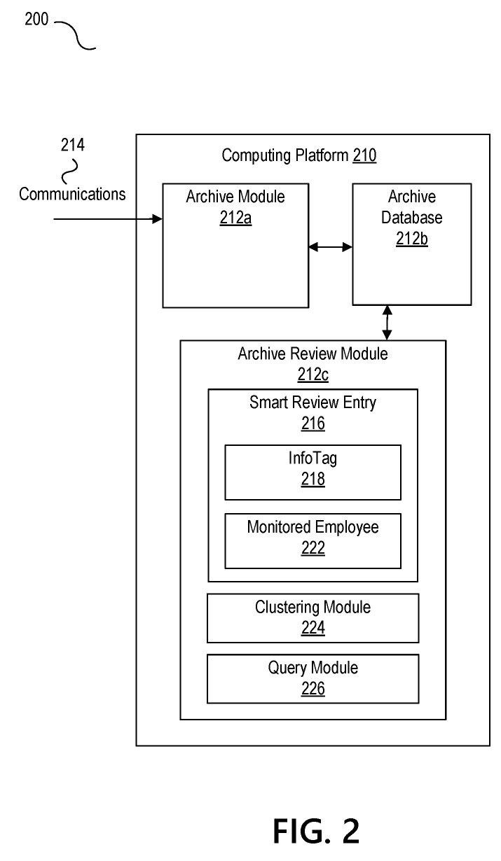

FIG. 2 is a block diagram of an example of a system 200 for performing targeted behavioral compliance monitoring. The system 200 includes a computing platform 210 that provides an archiving service. The computing platform 210 may include an archive module 212a that receives some or all digital communications 214 for each customer. Each customer may designate which communications 214 are stored in an archive database 212b based on regulatory or business decisions. The computing platform 210 may provide an unique archive database 212b for each customer. Thus, the communications stored in the archive for one customer are not commingled with the communications stored in the archive for other customers.

The archive module 212a may receive communications 214 for a customer that are designated to be stored in the archive database 212b. In one configuration, incoming communications 214 (e.g., emails, text messages, and chat messages) and outgoing communications 214 may be provided to the archive module 212a at approximately the same time as the communications 214 are sent to the recipient (so that the archive module 212a does not act as a man-in-the-middle). In another configuration, the customer may collect communications 214 (including received messages and sent messages) and provide them to the archive module 212a for archiving. The archive module 212a may store the communications 214 in an archive database 212b.

Communications 214 stored in the archive database 212b may be reviewed by an archive review module 212c. The archive review module 212cmay either review the communications 214 as they are being stored in the archive database 212b or at a later time (e.g., every hour or every day). For every communication 214 that is stored in the archive database 212b, the archive review module 212c may create a smart review entry 216 that includes one or more infoTags 218 for the communication 214 and the corresponding monitored employee 222. As an example, a message that includes text about taking a conversation offline and that includes social security numbers may have a single smart review entry 216 that identifies the monitored employee 222 and includes two infoTags 218: one for the language about taking the conversation offline and one for social security numbers. The tabular data from the smart review entries 216 is then normalized and clustered using the clustering module 224. For example, the smart review entries 216 may be fed to a self-organizing map neural network for clustering. The self-organizing map may be based on unsupervised learning that does not require human intervention. Training may be required for each new infoTag 218 that is added.

The data input to a smart review entry 216 may be structured as a table (a numeric matrix), where the columns represent the number of event instances occurring (for each infoTag 218) within a given time interval, and the rows correspond to the different users being monitored (i.e., the monitored employees 222). Each column represents a distinct event type, which can occur zero or more times for any user. Each time that a communication 214 from a monitored employee 222 matches an infoTag 218, the count for that infoTag 218 is incremented.

An infoTag 218 may be a full-text search query. An infoTag 218 may also include conditions on message metadata. When a communication 214 is processed, the infoTag 218 queries are executed against the communication 24 and any matches are recorded in the smart review entry 216. Each infoTag 218 may include very specific full-text queries or more general text queries (such as did the communication include the word “offline”).

The clustering module 224 may maintain the clustered smart review entries 216 corresponding to communications 214 stored in the archive database 212b. The clustered smart review entries 216 allow for the identification of cluster behavioral patterns, enabling an end user to explore the clustered smart review entries 216 using retrieval-augmented generation (RAG) of the communications 214 stored in the archive database 212b. This allows customers to define a much broader set of full-text search queries, increasing the rate of infoTag 218 matches for both true positives and false positives. The higher volume of matches can then be automatically analyzed to provide reviewers the ability to track individual monitored employees 222 for behavioral changes by observing shifts in the cluster smart review entries. Reviewers can also analyze entire clustered smart review entries 216 and the corresponding communications 214 with the support of large language models (LLMs) and retrieval-augmented generation (RAG).

For example, a corporation may begin tracking behavioral changes related to insider trading. In January, the corporation may define 1,000 infoTags 218 as full-text search queries targeting various aspects of insider trading. These queries, which are curated by business analysts, typically address topics such as stock prices, acquisitions, lawsuits, initial public offerings (IPOs), and similar areas. Each subsequent month, the archive review module 212c may count how many of these infoTags 218 are triggered by the communications 214 of a particular monitored employee 222. This data, combined with similar information from the monitored employee’s 222 colleagues, can be used to determine the monitored employee’s 222 position within a multidimensional behavior manifold. Over time, the archive review module 212cmay track that monitored employee’s 222 position month by month, enabling the archive review module 212c to calculate the distance between the behavior profiles of that monitored employee 222 in different periods. In this example, in September the monitored employee 222 becomes aware of a lawsuit that is progressing poorly and begins asking significantly more questions about it and its potential impact on the stock price (as detailed in their communications 214). This would result in a higher number of infoTags 218 being triggered by their communications 214, causing a noticeable shift in the position of the monitored employee 222 in the behavioral manifold for September. After the archive review module 212chas analyzed the data for September (i.e., analyzed the smart review entries 216), reviewers may observe a disproportionate increase in the distance between August and September for the monitored employee 222. Reviewers may also observe that the monitored employee 222 has been clustered into a completely different group of employees. The reviewer could then evaluate the communications 214 using a large language model (LLM) to determine whether there is a risk the monitored employee 222 is engaging in insider trading.

The archive review module 212c may also include a query module 226. The query module 226 may allow an authorized user (such as an administrator) to query the clustered smart review entries 216. The query module 226 may provide a user interface (UI) for a user to utilize natural language querying within selected clustered smart review entries 216, allowing for efficient and accurate supervision of the communications 214 stored in the archive database 212b.

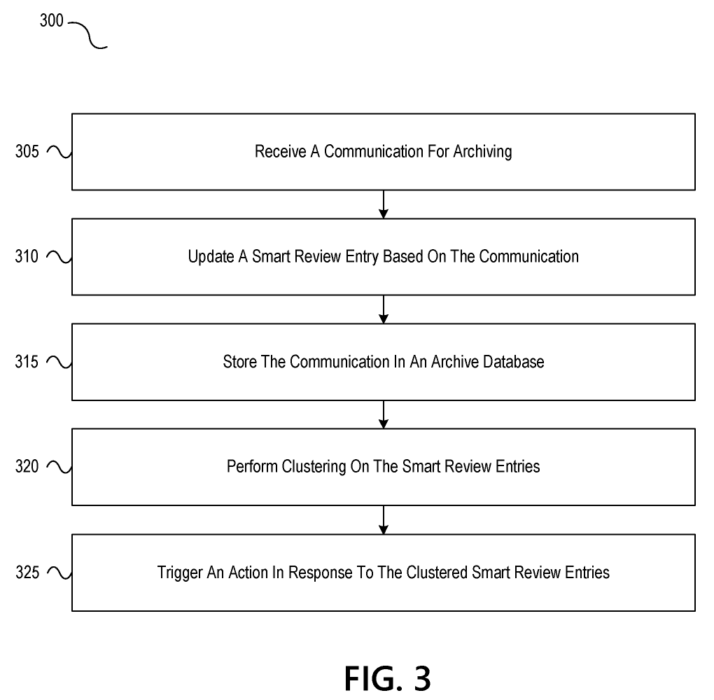

FIG. 3 is an example of a technique 300 for clustering smart review entries for communications stored in an archive database. The technique bcan be executed using computing devices, such as the systems, hardware, and software described with respect to FIGS. 1-2. The technique 300 can be performed, for example, by executing a machine-readable program or other computer-executable instructions, such as routines, instructions, programs, or other code. The steps, or operations, of the technique 300 or another technique, method, process, or algorithm described in connection with the implementations disclosed herein can be implemented directly in hardware, firmware, software executed by hardware, circuitry, or a combination thereof. The technique 300 can be performed by a software platform.

At 305, a communication 214 is received for archiving. The communication 214 may be an email, a text message, a chat message, a transcript of a voice conversation or phone call, or any other message. The communication 214 may be directed to or from a monitored employee 222 (i.e., a person that has agreed to have their messages and conversations monitored for compliance with regulations).

At 310, a smart review entry 216 is updated based on the communication 214. For example, a smart review entry 216 may be created or updated to indicate that an email was sent by a monitored employee 222 and that the email matched an infoTag 218 preselected for that monitored employee 222 (i.e., text within the email was sufficiently similar to the text in the infoTag 218). Not every monitored employee 222 may have the same preselected infoTags 218. For example, a finance employee (with access to confidential insider information) may have preselected infoTags 218 for financial information and trading information while a data science employee (with access to customer personally identifiable information (PII)) may have presented infoTags 218 for social security numbers and customer names. Updating the smart review entry 216 may include incrementing each infoTag 218 that matches the communication 214.

At 315, the communication 214 is stored in an archive database 212b. The communication 214 may be stored based on certain compliance requirements (such as that all messages to and from monitored employees 222 be stored for 5 years). An employer may choose to store certain communications 214 in the archive database 212b for longer than required by regulations.

At 320, clustering is performed on the smart review entries 216. Behavioral patterns within the smart review entries 216 may indicate which monitored employees 222 are behaving suspiciously. For example, if a group of monitored employees 222 have been tagged for a certain suspicious behavior (such as mentions of insider trading), those behaviors (i.e., those incremental increases in the infoTags 218 for the suspicious behavior) may be clustered together. In one configuration, two levels of clustering may be performed: a first clustering by a neural network and a second clustering using K-means to reduce the smart review entries 216 even further. The clusters may then be fed to a large language model (LLM) to further enhance the review process with natural language querying capabilities. The clustered smart review entries 216 may thus show groups of monitored employees 222 whose actions (i.e., communications 214 that matched infoTags 218) were outliers from other monitored employees.

At optional step 325, an action may be triggered in response to the clustered smart review entries 216. For example, an email or notification may be provided to a supervisor indicating that a monitored employee 222 has sent an email indicating intent to rob the bank that they work at (with an infoTag 218 for robbing a bank being incremented in response). The smart review entry 216 for the monitored employee 222 corresponding to the infoTag 218 exceeding a threshold count may trigger notification of the email to an administrator or superior so that action can be taken to prevent the monitored employee 222 from hurting others. The notification may be immediate or delayed based on the configuration of rules corresponding to each infoTag 218 and the capabilities of the archive review module 212c. In one configuration, the action may include automatically sending stalling information to the monitored employee 222 (such as distracting urgent emails), shutting down computer or access card privileges for the monitored employee 222, or notifying the police of the information in the email. More complex rules may also be utilized for triggering the action, such as only triggering the action when three or more monitored employees 222 have each sent or received messages triggering at least two of a particular infoTag 218 within a 30 day period. The rules for triggering actions may be set by the employer or by a regulating agency. The rules for triggering actions may also be set by the LLM. For example, an administrator could ask the LLM to generate complex rules and corresponding actions to best protect the company regarding compliance, data exfiltration, employee safety, or customer data.

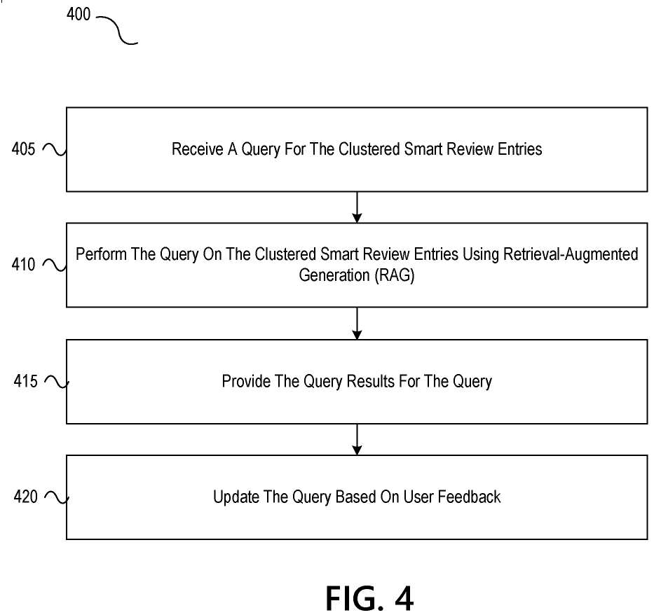

FIG. 4 is an example of a technique 400 for querying clustered smart review entries 216 for communications 214 stored in an archive database 212b. The technique 400 can be executed using computing devices, such as the systems, hardware, and software described with respect to FIGS. 1-2. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof. The technique 400 can be performed by a software platform.

At 405, a query is received for the clustered smart review entries 216. The query may be specifically directed to the clustered smart review entries 216 or the query may be a general query that is directed to the clustered smart review entries 216 based on the language within the query. In one configuration, the query may use natural language to request information about suspicious behavior. For example, the query may be for the archive review module 212cto find and display patterns of suspicious behavior by monitored employees 222. A large language model (LLM) may be utilized on the query to generate an appropriate query for the clustered smart review entries 216. The query may allow an administrator to ask questions about what identified outliers (from the clustered smart review entries 216) have in common.

At 410, the query is performed on the clustered smart review entries 216 using retrieval-augmented generation (RAG) to find the outliers and interrogate them. The query may thus be able to access the full language within the communications 214 stored in the archive database 212b (as well as the smart review entries 216 with the incremented infoTags 218) to find suspicious behavior across monitored employees 222. For example, the query may find patterns of suspicious behavior across thousands of monitored employees 222 and hundreds of thousands of archived communications 214 of varying modalities (such as emails, texts, chats, and transcripts of phone conversations).

At 415, the archive review module 212c may provide the query results for the query. The query results may include text from communications 214 related to the communications 214 that matched an infoTag 218. For example, the query results may include the full text of emails sent just before or just after the communication 214 that triggered an incremental increase in a particular infoTag 218. A company could choose to use as many infoTags 218 as they deem necessary, since more infoTags 218 utilized will result in more accurate data about the behaviors of monitored employees 222. Furthermore, because the infoTags 218 are queried by one system, a single LLM can see all of the information for select clusters (and can thus spot patterns and trends that are not currently visible to reviewers when a communication 214 triggers a specific infoTag 218). The query results can create links between different communications 214, different infoTags 218, and different monitored employees 222 across different languages. Thus, the query results can spot trends that suggest an employee in Boston is conspiring with an employee in Shanghai to steal company secrets.

At 420, the archive review module 212c may update the query based on user feedback. For example, the user (i.e., the query requestor) may ask that the query be for a different date period or that the results of the query be further filtered to produce fewer and/or stronger results. As another example, the user may request that the query also find other similar suspicious behavior by one of the monitored employees 222 identified in the query results.

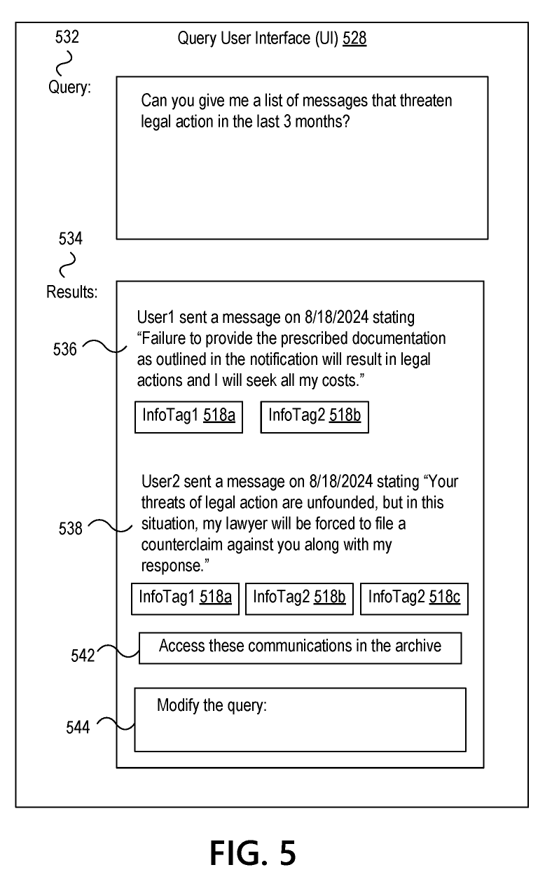

FIG. 5 is a block diagram illustrating an example user interface (UI) 528 for a query 532 and corresponding results 534 on clustered smart review entries 516. The query UI 528 may be displayed on a user computing device 130 (such as an endpoint device) utilized by a query requestor. In one configuration, the query UI 528 may be generated by an archive review module 212c. The query UI 528 may include space for a natural language query 532, such as “Can you give me a list of messages that threaten legal action in the last 3 months.” Because the query 532 is provided to an LLM, the LLM may ask follow up questions (such as whether the query should be expanded to 95 days to capture additional results).

The query UI 528 may also include space for the results 534. The results 534 may include text from the archived communications 214 (obtained using retrieval-augmented generation (RAG)). For example, the first result 536 illustrated is a message by User1 (a monitored employee 222) that was sent on 8/18/2024 stating “Failure to provide the prescribed documentation as outlined in the notification will result in legal actions and I will seek all my costs.” The first result 536 may also include information about which infoTags 218 were incremented based on the text in the communication 214 (infoTag1 518a and infoTag2 518b). The second result 538 illustrated is a message by User2 to User1 (a monitored employee 222) stating “Your threats of legal action are unfounded, but in this situation, my lawyer will be forced to file a counterclaim against you along with my response.” The second result 538 may include the infoTags 218 incremented by the communication 214 (infoTag1 518a, infoTag2 518b, and infoTag3 518c), allowing the user of the query user interface (UI) 528 to see connections between the results 534.

The results 534 may include a link 542 to the communications 214 in the archive database 212c, allowing the user of the query user interface (UI) 528 to access additional information about each of the results 534 (such as messages sent immediately before or immediately after the tagged message or other suspicious behaviors of the users (e.g., User1 and User2)). The results 534 may further include space to modify the query 544 (such as to find additional outliers, find other messages that were tagged with related infoTags 218 such as infoTag4 or infoTag5 for either the users, their peers, other monitored employees 222 on the same team or the same floor or in the same building, or other connections that might be found by the LLM and not typically be discernible to a human). A user of the query user interface (UI) 528 may thus be able to iterate queries 532 to find suspicious patterns.

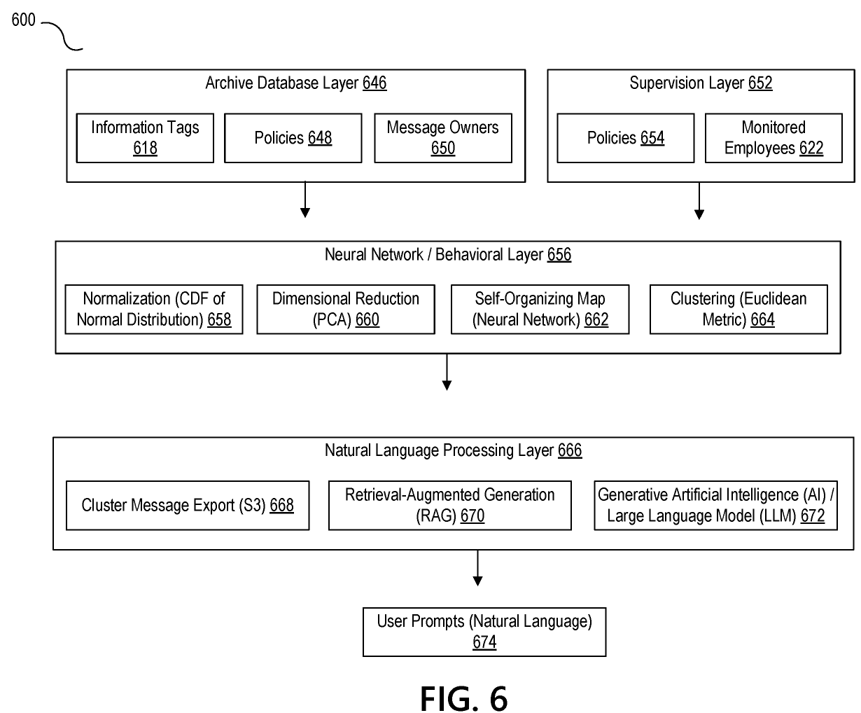

FIG. 6 is a block diagram illustrating the solution stack 600 for clustering smart review entries 216. The solution stack 600 may include an archive database layer 646. The archive database layer 646 may be a component of the archive database that is optimized from fast query execution against primitive data types. In one configuration, the archive database layer may be an Apache Solr layer that includes infoTags (or information tags 618), policies 648, and message owners 650. The solution stack 600 may also include a supervision layer 652. The supervision layer 652 may include policies 654 and monitored employees 622.

The solution stack 600 may include a neural network/behavioral layer 656. The neural network/behavioral layer 656 may include a normalization 658 (such as a cumulative distribution function (CDF) of normal distribution), a dimensional reduction (principal component analysis (PCA)) 660, a self-organizing map (neural network) 662, and clustering (Euclidean metric) 664. The Euclidean metric may be chosen for clustering because of the ease of calculating distances within the metric.

The solution stack 600 may include a natural language processing layer 666. The natural language processing layer 666 may include a cluster message export (S3) 668, retrieval-augmented generation (RAG) 670, and a generative artificial intelligence (AI) tool 672 such as a large language model (LLM). The solution stack 600 may also include user prompts 674, which can generate queries for the clustered smart review entries 218 using natural language.

For simplicity of explanation, the techniques 300 and 400 of FIGS. 3 and 4 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for targeted behavioral compliance monitoring, comprising:
clustering smart review entries corresponding to communications stored in an archive, wherein each smart review entry corresponds to a communication, by a monitored employee, that matched an infoTag;
receiving a query for the clustered smart review entries, wherein the query is a natural language query;
performing the query on the clustered smart review entries using retrieval-augmented generation (RAG); and
providing query results from the query for display in a user interface (UI).

2. The method of claim 1, further comprising triggering an action in response to the clustered smart review entries.

3. The method of claim 2, wherein the action comprises automatically sending stalling information to one or more monitored employees when a count for an infoTag corresponding to a crime has exceeded a threshold count for each of the one or more monitored employees.

4. The method of claim 2, wherein the action comprises sending a notification email to each supervisor of one or more monitored employees when a count for a specific infoTag has exceeded a threshold count for each of the one or more monitored employees.

5. The method of claim 2, wherein the action is suggested by a large language model (LLM) in response to the smart review entries and infoTag counts.

6. The method of claim 1, further comprising updating the query results based on user feedback.

7. The method of claim 1, wherein clustering the smart review entries comprises:
feeding the smart review entries to a self-organizing map neural network based on unsupervised learning; and
refining results from the self-organizing map neural network using K-means.

8. The method of claim 7, wherein the refined results are fed to a large language model (LLM) to enhance reviewing with natural language capabilities.

9. The method of claim 1, wherein each communication by a monitored employee that matches the infoTag increments a count for the infoTag in the smart review entry.

10. The method of claim 1, wherein the query indicates groups of monitored employees whose actions are outliers from other monitored employees.

11. The method of claim 1, wherein the query results include communications related to the communication that matched the infoTag.

12. A computing platform, comprising:
a memory; and
a processor, the processor configured to execute instructions stored in the memory to:
cluster smart review entries corresponding to communications stored in an archive, wherein each smart review entry corresponds to a communication, by a monitored employee, that matched an infoTag;
receive a query for the clustered smart review entries, wherein the query is a natural language query;
perform the query on the clustered smart review entries using retrieval-augmented generation (RAG); and
provide query results from the query for display in a user interface (UI).

13. The computing platform of claim 12, wherein clustering the smart review entries comprises:
feeding the smart review entries to a self-organizing map neural network based on unsupervised learning; and
refining results from the self-organizing map neural network using K-means.

14. The computing platform of claim 13, wherein the refined results are fed to a large language model (LLM) to enhance reviewing with natural language capabilities.

15. The computing platform of claim 12, wherein each communication by a monitored employee that matched the infoTag increments a count for the infoTag in the smart review entry.

16. The computing platform of claim 12, wherein the query indicates groups of monitored employees whose actions are outliers from other monitored employees.

17. A non-transitory computer readable medium storing instructions operable to cause one or more processors to perform operations comprising:
clustering smart review entries corresponding to communications stored in an archive, wherein each smart review entry corresponds to a communication, by a monitored employee, that matched an infoTag;
receiving a query for the clustered smart review entries, wherein the query is a natural language query;
performing the query on the clustered smart review entries using retrieval-augmented generation (RAG); and
providing query results from the query for display in a user interface (UI).

18. The non-transitory computer readable medium of claim 17, wherein clustering the smart review entries comprises:
feeding the smart review entries to a self-organizing map neural network based on unsupervised learning; and
refining results from the self-organizing map neural network using K-means.

19. The non-transitory computer readable medium of claim 18, wherein the refined results are fed to a large language model (LLM) to enhance reviewing with natural language capabilities.

20. The non-transitory computer readable medium of claim 17, wherein each communication by a monitored employee that matched the infoTag increments a count for the infoTag in the smart review entry.
